(19) United States
(12) Patent Application Publication
(10) Pub. No.: US 2009/0272709 A1
(43) Pub. Date: Nov. 5, 2009

(54) PORTABLE PILLAR-MOUNTABLE HOIST

(76) Inventors: Thomas J. Nessner, Zeeland, MI (US); Kristi J. Nessner, Zeeland, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/435,021

(22) Filed: May 4, 2009

Related U.S. Application Data
(60) Provisional application No. 61/050,012, filed on May 2, 2008.

(51) Int. Cl. B66C 1/00; B66F 9/00

(52) U.S. Cl. 212/270; 254/262

(57) ABSTRACT

A portable hoist apparatus that can be quickly, easily and recurrently mounted on a tree or other pillar-like structure, which causes very little or no damage to the pillar-like structure, includes a hoist member having a base, a boom projecting from the base, and a support flange; and an adjustably tensionable strap for engaging the support flange and attaching the hoist member to the pillar-like structure. The portable hoist apparatus may be used by hunters to easily lift a tree stand to a desired position on a tree, or by utility workers to easily raise tools or other heavy or awkward objects up along a utility pole.

### CROSS REFERENCE TO RELATED APPLICATION

This application claims priority under 35 U.S.C. § 119(e) on U.S. Provisional Application No. 61/050,012 entitled PORTABLE PILLAR-MOUNTABLE HOIST, filed May 2, 2008, the entire disclosure of which is incorporated herein by reference.

### FIELD OF THE INVENTION

This invention pertains to a hoisting device that is attachable to a tree trunk, pole or similar pillar-like structure to allow objects to be lifted upwardly along the tree trunk, pole or similar pillar-like structure, and to a method of lifting objects upwardly along a tree trunk, pole or similar pillar-like structure without causing substantial damage to the tree, pole or similar pillar-like structure.

### BACKGROUND OF THE INVENTION

Lifting heavy objects and/or objects having an awkward shape up along a pole or tree can be difficult and dangerous. Telephone linesmen, Power Company personnel, and other utility workers may resort to use of hydraulic lifting equipment when there is a need to raise heavy or bulky objects upwardly along a utility pole. However, there may be occasions in which such equipment could be impractical or unavailable on an economical and/or timely basis. Similarly, individuals without access to hydraulic lifting equipment may on occasion have a need for raising objects upwardly along a tree or pole. For example, hunters can often find it difficult to carry a tree stand up a tree and mount the tree stand on the tree.

A purpose of the invention is to provide a device and method that allows objects to be safely, easily and economically lifted up a tree, pole or other pillar-like object. Desirably, the device is extremely compact and extremely light in weight so that it can be easily carried by a person, such as in a pocket or pouch, and can be easily attached on a tree, pole or other pillar-like object.

### SUMMARY OF THE INVENTION

In one aspect of the invention, a hoist member that is attachable to a pillar, such as with a strap is provided. The hoist member includes a base having a pillar engaging side and an opposite lifting side, a boom projecting from the lifting side of the base, and at least one support flange extending from the boom side of the base. The support flange is configured to be engaged by an upper edge of a strap, allowing the hoist member to be securely retained on the pillar.

In accordance with another aspect of the invention, a hoist system that is attachable to a pillar is provided. The hoist system includes a hoist member as described above, and an adjustably tensionable strap for attaching the hoist member to a pillar.

In accordance with a further aspect of the invention, a method of lifting an object upwardly along a pillar is provided. The method includes providing a hoist system as described above, attaching a pulley to a distal end of the boom, looping a rope around the pulley, attaching an object to be lifted to one section of the rope, and pulling another section of the rope downwardly to raise the object.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a perspective view of an embodiment of the invention being used on a tree.

FIG. 2 is an enlarged perspective view of the hoist member shown in FIG. 1.

FIG. 3 is a fragmentary front elevational view of the hoist member of FIG. 1, showing in greater detail a pulley assembly connected to the hoist member.

FIG. 4 is a side elevational view of a strap assembly used in accordance with the invention to securely retain the hoist member on a tree or other pillar-like structure.

FIG. 5 is a perspective view of a strap assembly suitable or securing the hoist member to a tree or other pillar-like structure.

FIG. 6 is a photograph showing a tree stand having a cross-member supported on the boom of the hoist member.

### DETAILED DESCRIPTION OF PREFERRED EMBODIMENTS

The invention disclosed herein provides a portable device that can be easily carried by a person and easily attached to a tree, pole or other pillar-like object to allow heavy and/or awkward or bulky loads to be safely and easily lifted upwardly along the tree, pole, or other pillar-like object.

The invention will generally be described with respect to its use for mounting a tree stand on a tree, such as for hunting. However, it is believed that the invention has many other applications, and may be particularly beneficially employed by utility workers having a need to raise certain objects upwardly along a pole that cannot necessarily be easily carried by a worker climbing the utility pole, but for which hydraulic lifting equipment constitutes excessive means for achieving the desired lift.

As used herein, the term “pillar-like object” and “pillar” are used synominously to refer to various vertically oriented elongate structures encompassing trees, utility poles, architectural columns, and similar structures.

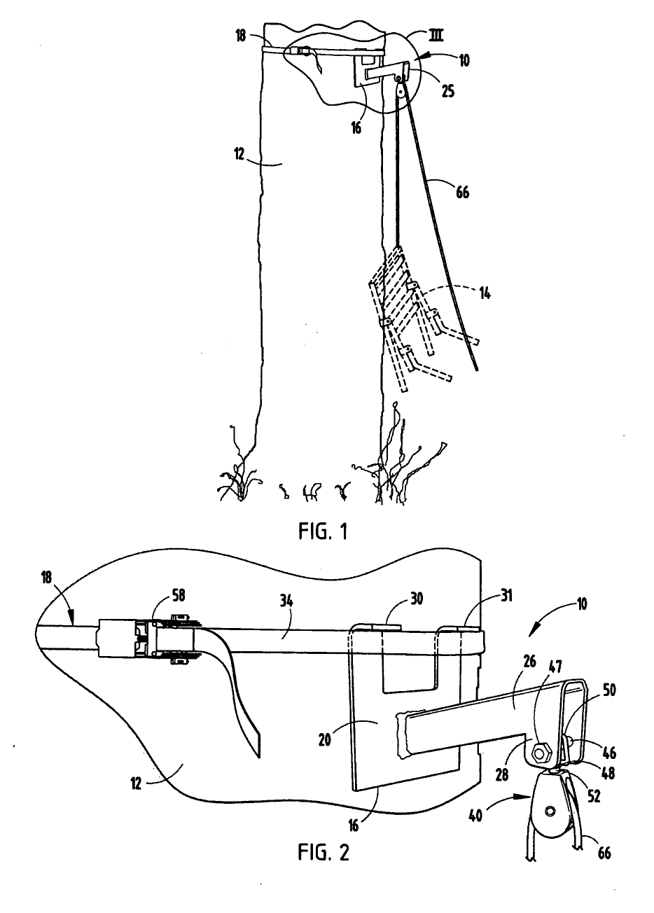

FIG. 1 shows a hoist system 10 in accordance with the invention mounted on a tree 12 to allow a load 14 to be lifted upwardly along the tree trunk 12. The hoist system includes a hoist member 16, and a strap assembly 18.

Hoist member 16 includes a base 20 comprised of a metal sheet. While a suitable sheet metal material and gauge or thickness may be selected based on the desired load capability of the hoist system, 16 gauge ( 1/16 inch thick) carbon steel is adequate for loads up to at least 100 pounds, which is well in excess of the weight of most tree stands or other objects that a hunter may typically want to lift upwardly along a tree. Base 20 includes a pillar or tree engaging side 22 and an opposite lifting side 24 (FIG. 4). Base 20 may be relatively flat, or it may be slightly curved to generally conform to the shape or curvature of a typical tree that is suitable for mounting a hunting stand.

Projecting from base 20 is a boom 26. Boom 26 preferably projects slightly upwardly away from base 20. Boom 26, may be made of the same material as base 20 to facilitate welding of boom 26 to base 20. Boom 26 may be made by bending metal sheet (e.g., carbon steel) to form a generally inverted U-shaped channel, which may be cut or stamped, prior to bending, to include downwardly depending tabs 28 at a distal end of boom 26. As with base 20, boom 26 may be formed of 16 gauge ( 1/16 inch thick) carbon steel sheet to provide an adequate margin of safety for lifting a load up to at least 100 pounds. As previously mentioned, and as well known in the art, different materials (e.g., stronger materials) and/or different thicknesses may be used, as needed, to accommodate heavier or lighter loads.

In the illustrated embodiment, support flanges 30, 31 are formed by bending prongs 32, 33 of base 20 downwardly so that they project away from base 20 at approximately a right angle (about 90 degrees). However, this angle is not critical, and could be less or more. Similarly, a single flange, or more than two flanges, may be used, the purpose of support flanges 30, 31 being to support hoist member 16 on an upper edge of a strap 34 as strap assembly 18 is being tensioned, and to prevent hoist member 16 from slipping downwardly between strap 34 and a pillar or tree 12 when a load is applied to the hoist assembly.

While the angle of support flanges 30, 31 with respect to base 20 is not critical, an approximately right angle is beneficial for allowing a tree stand to be temporarily positioned at a desired location for installation on a tree by supporting the tree stand on top of boom 26 and/or against flanges 30, 31. As shown in FIG. 6, a cross-member 70 of tree stand 72 is supported or balanced on boom 26 to allow a person to use both hands to install (e.g., strap) tree stand 72 to tree 74. This is facilitated by the angle between boom 26 and base 20 of hoist member 16, i.e., an angle formed by having boom 26 project slightly upwardly as it projects away from base 20. A suitable angle from horizontal for boom 26 (when base 20 is vertically oriented) is about 5° to about 20°.

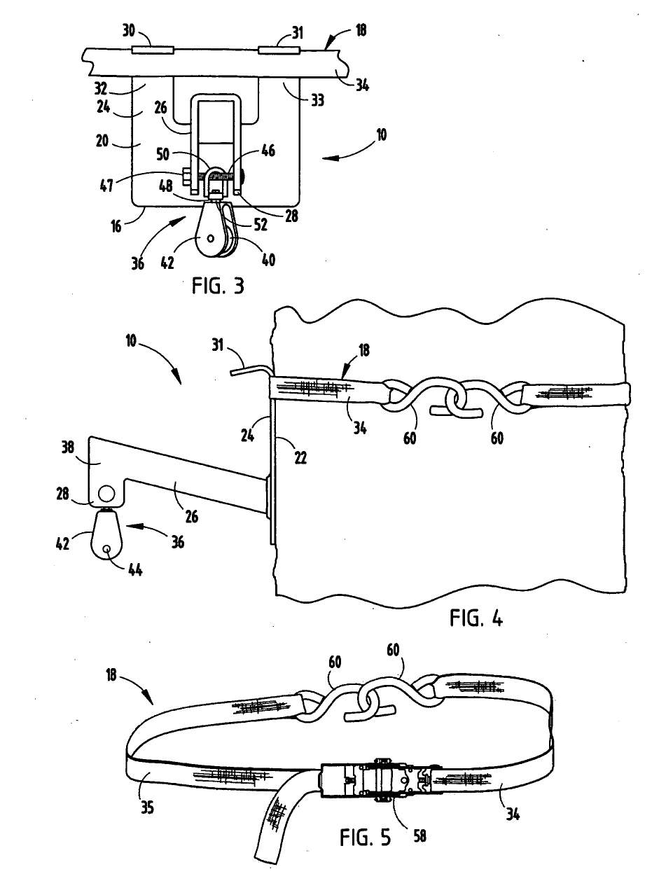

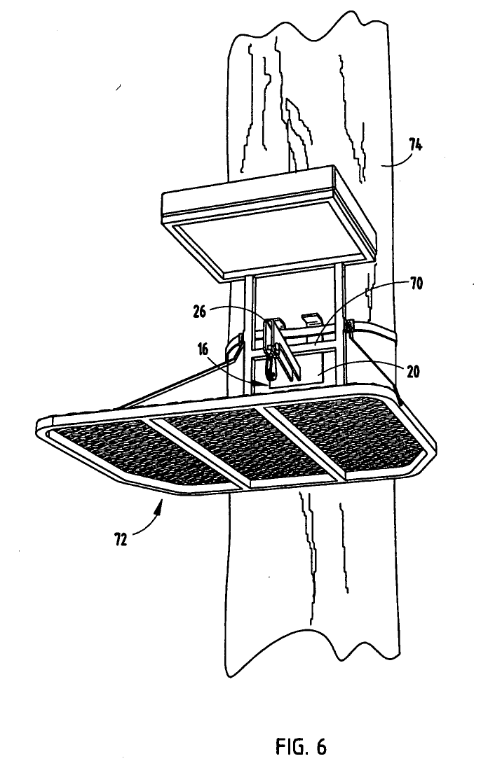

A pulley assembly 36 is mounted near a distal end 38 of boom 26, as shown in FIG. 4. Illustrated pulley assembly 36 (best illustrated in FIG. 3) includes a pulley 40 rotatably supported on or journaled to a pulley support bracket 42 by a pulley pin or axle 44. A pulley support rod 46 extends through tabs 28 at the distal end of boom 26 to support pulley assembly 36. Pulley support rod 46 may, for example, be comprised of a bolt held by a nut 47. Pulley assembly 36 also includes a linkage 48 for connecting pulley support bracket 42 to pulley support rod 46. Linkage 48 includes a ring 50 that encircles pulley support rod 46, and a swivel connector 52 that allows pulley 40 and pulley support bracket 42 to be rotated around a generally vertical axis as it is suspended from the distal end of boom 26.

A rope 66, cord, cable or the like may be threaded around the upper bearing surface of pulley 40. The expression “rope” as used herein will refer to any flexible rope-like element that may be threaded around the upper bearing surfaces of pulley 40 and used for lifting a load 14. Generally, for weights up to about 100 pounds, the load can be lifted manually and tied to a stationary object, such as the branch of another tree. However, for hoist systems designed to accommodate greater weights, or if otherwise desired, the rope can be connected to a vehicle, manual winch, powered winch, etc., to raise the load.

Strap assembly 18 includes strap sections 34, 35 with a ratchet assembly 58 connecting the strap sections 34, 35 together. At ends of straps 34, 35 opposite the ends attached to racket assembly 58, rubber-coated metal J-hooks 60 (e.g., carbon steel hooks) are connected to the straps. Suitable ratchet assemblies that may be employed are described, for example, in U.S. Pat. Nos. 6,682,053 and 7,281,701, which are incorporated by reference.

Although it is preferred that the strap assembly include a hand-operated ratchet mechanism 58 for easily tensioning strap assembly 18, it is envisioned that other tensioning means and/or strap locking mechanisms may be employed.

Strap sections 34, 35 are preferably comprised of durable, weather-resistant woven fabrics comprised of nylon, polypropylene, and/or polyester filaments. Heavy duty straps of this type are commercially available and are commonly employed for strapping loads in trailer trucks, vans and the like.

The hoist system of the invention is installed on a tree, pole or other pillar-like structure by first wrapping strap assembly 18 around the pillar-like structure and connecting the ends of the strap assembly 18 together, such as by interlocking J-hooks 60 together and loosely adjusting the tension on strap assembly 18 to allow hoist member 16 to be slid under and supported by strap assembly 18 through engagement of support flanges 30, 31 with an upper edge of one of strap sections 34, 35. Thereafter, strap assembly 18 is tensioned to provide secure attachment of hoist member 18 to the pillar-like structure. A rope 66 may be looped around an upper bearing surface of pulley 40 to allow a load 14 to be raised upwardly along the pillar-like structure.

Because the hoist system of this invention employs only a tensionable strap assembly 18 for holding hoist member 16 on a tree or other pillar-like structure, mounting of hoist system 10 to a tree, utility pole, or the like does not cause any, or very little damage to the tree, utility pole or other pillar-like structure. The hoist system of the invention also reduces the risk of damage to equipment or injury to personnel during harvesting of the tree or recycling of a utility pole, by eliminating the possibility that hardened metal fasteners will be left concealed below the surface of a tree or pole.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A hoist member attachable to a pillar, comprising:
a base having a pillar engaging side and an opposite lifting side;
a boom projecting from the lifting side of the base; and
at least one support flange extending from the boom side of the base, the support flange being configured to be engaged by an upper edge of a strap.

2. The hoist member of claim 1, in which the boom has a distal end opposite an end attached to the base, and a pulley suspended from the boom at a location in proximity to the distal end of the boom.

3. The hoist member of claim 2, in which the pulley is supported on a swivel connection.

4. The hoist member of claim 3, in which the swivel connection is supported on a bolt extending through a distal end of the boom.

5. The hoist member of claim 1, in which the boom is comprised of a channel shaped sheet metal member.

6. A hoist system attachable to a pillar, comprising:
a hoist member, including a base having a pillar engaging side and an opposite lifting side, a boom projecting from the lifting side of the base, and at least one support flange extending from the boom side of the base, the support flange being configured to be engaged by an upper edge of a strap; and
a strap assembly comprising straps for attaching the hoist member to a pillar.

7. The hoist system of claim 6, in which the boom has a distal end opposite an end attached to the base, and a pulley suspended from the boom at a location in proximity to the distal end of the boom.

8. The hoist system of claim 7, in which the pulley is supported on a swivel connection.

9. The hoist system of claim 8, in which the swivel connection is supported on a bolt extending through a distal end of the boom.

10. The hoist system of claim 6, in which the boom is comprised of a channel shaped sheet metal member.

11. The hoist system of claim 6, wherein the strap assembly includes a hand-operated racket assembly for tensioning the strap assembly.

12. The hoist system of claim 6, wherein the strap assembly includes hooks for connecting ends of the strap assembly around a pillar.

13. The hoist system of claim 12, wherein the hooks are rubber-coated metal hooks.

14. A method of lifting an object upwardly along a pillar, comprising:
providing a hoist member including a base having a pillar engaging side and an opposite lifting side, a boom projecting from the lifting side of the base, and at least one support flange extending from the boom side of the base, the support flange being configured to be engaged by an upper edge of a strap, and a pulley supported from the boom;
strapping the hoist member to the pillar with a strap assembly;
looping a rope around a bearing surface of the pulley, the rope having first and second sections extending downwardly from the pulley;
attaching an object to be lifted to one of the sections of the rope; and
pulling the second section of the rope downwardly to lift the object upwardly along the pillar.
